(19) United States
(12) Patent Application Publication
(10) Pub. No.: US 2010/0188996 A1
(43) Pub. Date: Jul. 29, 2010

(54) ANALYSIS DEVICE FOR DETECTING MOBILE COMMUNICATION NETWORKS PROVIDING A CHOSEN QUALITY OF SERVICE, FOR A MOBILE COMMUNICATION EQUIPMENT

(75) Inventor: Frederice Ruelle, Vienna (FR)

Correspondence Address: HOGAN LOVELLS US LLP, ONE TABOR CENTER, SUITE 1500, 1200 SEVENTEENTH ST, DENVER, CO, 80202, US

(73) Assignee: NXP. B.V.

(21) Appl. No.: 12/447,244

(22) PCT Filed: Oct. 3, 2007
(86) PCT No.: PCT/IB07/54019

§ 371 Date: Feb. 4, 2010

(30) Foreign Application Priority Data
Oct. 31, 2006 (EP) 06291701.8

(51) Int. Cl. H04L 12/26

(52) U.S. Cl. 370/252

(57) ABSTRACT

An analysis device installed in mobile communication equipment includes a communication module for collecting information about mobile communication networks providing known capabilities which may offer service(s), to which the analysis device can connect the mobile communication equipment. The analysis device includes a detection means for determining from information collected by the communication module if one of the mobile communication networks is an accessible mobile communication network providing a chosen quality of service to which the mobile communication equipment is not already connected, and a control means for connecting to a newly determined accessible mobile communication network

### FIELD OF THE INVENTION

The present invention relates to mobile (or cellular) communication networks and more precisely to the accessibility of mobile (or cellular) communication equipments to services that are offered by mobile (or cellular) communication networks through (radio) access networks.

### BACKGROUND OF THE INVENTION

In the following description one means by “communication equipment” any type of mobile (or portable or cellular) (tele)communication equipment intended for establishing connections with mobile (or cellular) communication networks through (radio) access networks of at least one access technology. So, it may be a mobile telephone, a personal digital assistant (PDA) or a laptop, for instance.

Moreover in the following description one means by “communication network” any type of mobile (or cellular) communication network intended for establishing communications with mobile (or cellular) communication equipments through (radio) access networks of any type of access technology. So, it may be a GSM network, a GPRS/EDGE network, an UMTS network, a CDMA (2000) network, and any of their equivalents, a wireless local area network (WLAN), or a Bluetooth network, for instance. One will notice that an access network can be made of only one or several access points.

The user of a communication equipment (hereafter called mobile equipment) usually contracts a subscription near a network operator in order to get a defined service, such as GSM or GPRS. So when this user switches his mobile equipment on, he expects to get the service he subscribed to (for a determined cost). So, from the user point of view, a good mobile equipment is a mobile equipment which allows him to get the subscribed service as often as possible, and when this subscribed service is not accessible in the area where he is located, to get a service as good as possible.

A subscribed service can be inaccessible when a mobile equipment is connected to a visited PLMN (“Public Land Mobile Network”) but not to its home PLMN. In such a situation, the international recommendations propose to implement an algorithm allowing the mobile equipment to try to go back to its home PLMN or at least to a PLMN with a higher priority than the visited PLMN when it is not registered on it. Indeed, according to the 3GPP technical specification TS 23.122 (§4.4.4.3), if the mobile equipment is in a visited PLMN, it must periodically attempt to obtain the subscribed service on its home PLMN or a higher priority PLMN than the visited PLMN, which is listed in the user controlled PLMN selector (list of favourite PLMNs stored in the SIM card) or the operator controlled PLMN selector, by scanning in accordance with the requirements defined in the Automatic Network Selection Mode in clause 4.4.3.1.1.

If the mobile equipment stores a list of equivalent PLMNs, it can only select a PLMN if it is of a higher priority than the PLMNs which are listed in the equivalent PLMN list and are of the same country as the visited PLMN.

A time delay T may be stored in the mobile equipment SIM, in order the mobile equipment tries to go back periodically to its home PLMN. T is usually comprised between 6 minutes and 8 hours. If no time delay value is stored in the SIM, a default value of 60 minutes can be used or it can be specified in the SIM that no periodical attempt shall be done.

So, the mobile equipment can manage the search for a highest priority PLMN in a completely automatic mode, but irrespective of the quality of service that provides this highest priority PLMN. Therefore, if the user does not try to access to a PLMN providing a chosen quality of service on his own initiative, the service provided by the PLMN, to which his mobile equipment is connected to, can be kept for a long time even if a better quality of service could be accessed.

### OBJECT AND SUMMARY OF THE INVENTION

So, the object of this invention is to improve the situation and more precisely to allow a user to access more easily and quicker to a better quality of service than the one provided by the mobile (or cellular) communication network to which his mobile equipment is connected to, while respecting, if possible, the ETSI recommendations.

For this purpose, it provides an analysis device, intended for being installed into a mobile (or cellular) communication equipment (“mobile equipment”) comprising a communication module arranged for collecting information relative to radio communication networks providing known capabilities which may offer service(s) and to which it is capable of connecting said equipment (MS), and comprising:
a detection means arranged for determining amongst the information collected by the communication module if one is relative to an accessible mobile (or cellular) communication network which provides a chosen quality of service and to which said equipment (MS) is not already connected to, and
a control means arranged, when the detection means has determined such a connectable mobile (or cellular) communication network, for ordering to the communication module to try to connect its mobile equipment to this newly determined mobile (or cellular) communication network.

It is important to notice that the collected information is not limited to radiofrequency (RF) conditions and/or criteria in one or more cells, but it concerns any general information provided by a network and relative to one or more cells.

The analysis device according to the invention may include additional characteristics considered separately or combined, and notably:
its control means may be arranged for informing the user of the mobile equipment that the latter can be connected to a newly determined mobile (or cellular) communication network providing the chosen quality of service, and for ordering to the communication module to try to connect its mobile equipment to the newly determined mobile (or cellular) communication network if it receives an authorization from the user through its mobile equipment;
it may comprise a triggering means arranged for activating/deactivating its detection means and its control means at chosen moments in order they start/stop to determine a newly connectable mobile (or cellular) communication network providing the chosen quality of service;
   this triggering means may be of the programmable type;
its detection means may be arranged for using a definition of a chosen quality of service provided by the user by means of a man/machine interface (MMI) of the mobile equipment;
in a variant or in addition, its detection means may be arranged for building a definition of a chosen quality of service from information relative to the subscription the user has contracted near a network operator and for using this defined chosen quality of service by default.

The invention also provides a communication module intended for being installed in a mobile (or cellular) communication equipment and comprising an analysis device such as the one above introduced.

The invention further provides a mobile (or cellular) communication equipment comprising an analysis device or a communication device such as the ones above introduced.

### BRIEF DESCRIPTION OF THE DRAWINGS

Other features and advantages of the invention will become apparent on examining the detailed specifications hereafter and the appended drawings, in which:

FIG. 1 schematically illustrates three radiofrequency (RF) communication networks with partially overlapping radio covering areas, and

FIG. 2 schematically and functionally illustrates a mobile equipment comprising an example of embodiment of an analysis device according to the invention.

The appended drawings may not only serve to complete the invention, but also to contribute to its definition, if needed.

### DETAILED DESCRIPTION OF THE INVENTION

The invention aims at offering an analysis device intended for detecting mobile (or cellular) communication networks providing a chosen quality of service, for a mobile (or cellular) communication equipment (hereinafter called “mobile equipment”).

In the following description it will be considered that the mobile equipments (or mobile stations) are mobile (or cellular) telephones. However, the invention is not limited to this type of mobile equipment. It applies to any type of mobile (or cellular or else portable) communication equipment capable of establishing connections with mobile (or cellular) communication networks through (radio) access networks of at least one access technology. So, it may be also a personal digital assistant (PDA) or a laptop, for instance.

Moreover, in the following description it will be considered that the mobile (or cellular) communication networks are PLMNs, such as GSM networks, GPRS/EDGE networks and UMTS networks. However, the invention is not limited to this type of mobile (or cellular) communication network. It applies to any type of communication network, and notably to any type of PLMN, any type of wireless local area networks (WLANs) and to Bluetooth networks.

The invention proposes an analysis device D intended for selecting a mobile network which provides a chosen quality of service, for a mobile equipment MS in which it is installed.

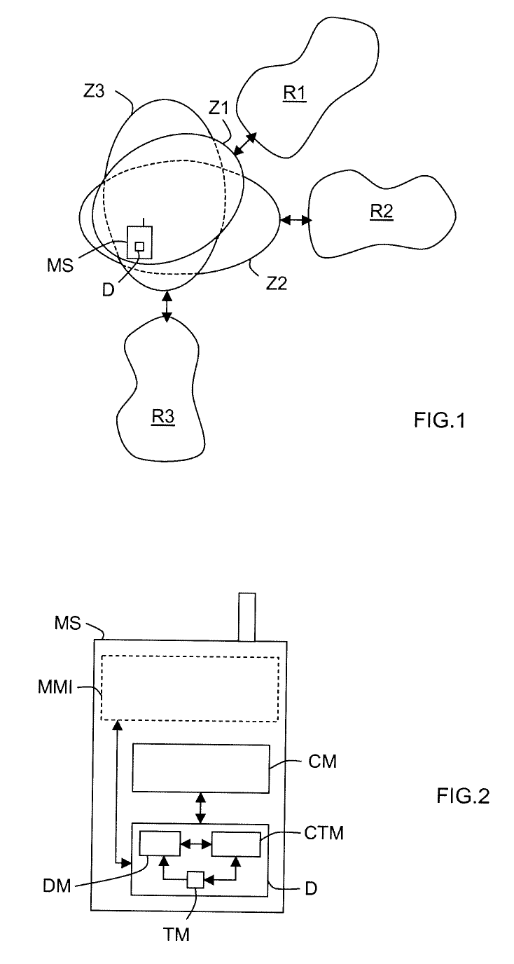

This invention is of real interest for a mobile equipment MS as soon as it is located in an area which is covered (in terms of communications) by at least two mobile (or cellular) communication networks (and more precisely two different (radio) access networks). Such a situation is schematically illustrated in FIG. 1.

More precisely, three mobile networks R1, R2 and R3 with partially overlapping radio covering areas Z1, Z2 and Z3 are illustrated in the non limiting example of FIG. 1. For instance, the mobile network R1 is an UMTS network, the mobile network R2 is a GPRS network and the mobile network R3 is an EDGE network. Any other combination of at least two mobile (or cellular) communication networks can be envisaged, as soon as they do not have the same cell characteristics and/or capabilities (even if they have the same access technology).

In this example, one considers that at a given moment a mobile equipment MS is located in an area where the radio covering areas Zi (i=1 to 3) of the mobile networks Ri are overlapping each other. So, at this given moment the mobile equipment MS is liable of being connected to anyone of them. However, if later on the mobile equipment MS is moved into an area where only two radio covering areas (for instance Z1 and Z3) are overlapping each other, the mobile equipment MS shall be liable of being connected only to the mobile networks R1 and R3.

As mentioned above and as schematically illustrated in FIG. 2, an analysis device D according to the invention is intended to be installed into a mobile equipment MS. Such a mobile equipment MS must comprise at least a communication module CM capable of collecting information relative to mobile networks Ri in the radio covering area Zi of which it is located, notably for establishing a (RF) connection with one of them, and also preferably a man/machine interface MMI intended notably for allowing a user to access information, to display information, to select items into displayed menus and to transmit commands. This communication module CM may be the transceiver of the mobile equipment MS or a part of this transceiver, or a WLAN or Bluetooth communication module, for instance.

The analysis device D comprises at least a detection module DM and a control module CTM.

The detection module DM is arranged for accessing to the information relative to the accessible mobile networks (i.e. those to which it could be immediately connected to), and notably the information defining the capabilities they provide (from which one can deduce the service(s) they may offer), which has been collected by the communication module CM of its mobile equipment MS.

This detection module DM is also arranged for determining amongst the collected information if one is relative to an “accessible” mobile network Ri which is capable of providing a chosen quality of service and to which the mobile equipment MS is not already connected.

One means here by “chosen quality of service” a quality of service which has been either defined (and selected) by the user of the mobile equipment MS by means of the man/machine interface MMI (possibly by selection of item(s) or criterion(a) in a group of items or criteria proposed in a dedicated menu), or defined by the detection module DM or by someone else from information relative to the subscription the user has contracted near his network operator and which must be used by default. The detection module DM is capable of collecting information relative to network capabilities but not to guaranty a service (notably because the use of a service requires a preliminary authorization from the network).

It is important to notice that the quality of service may be selected by the user between several stored definitions, by means of the man/machine interface MMI. When the definition of a default quality of service is stored with other definitions defined by the user, it is used by the detection module DM either if the user has not selected any definition or if it has been selected by the user.

Any definition of quality of service can be defined (or built). For instance, a definition can designate a GPRS service, or a UMTS service, or a specific radio access technology (RAT), such as an UMTS access or a WLAN access, or a list of favourite (radio) access technologies, or else a 2.5G access technology (GSM/GPRS) implementing DTM (“Dual Transfer Mode”) in cell(s) (for instance to allow voice call and video transmission in parallel).

Of course, the chosen quality of service must be compatible with the user subscription. Therefore, if the detection module DM must use a definition which has been defined and selected by the user, it may be arranged for comparing this selected definition with the characteristics of the user subscription (for instance stored into the SIM card or into a static memory (such as an EEPROM)) before using it.

When the detection module DM has determined a “connectable” mobile network Ri which could be accessed immediately and which can provide the chosen quality of service, it informs the control module CTM.

This control module CTM is arranged, when it is informed of the existence of a connectable mobile network Ri by the detection module DM, for ordering to the communication module CM to try to connect its mobile equipment MS to this newly determined mobile network Ri.

It is important to notice that before transmitting a connection order to the communication module CM it is preferable that the control module CTM gets an authorisation from the user. To this effect, the control module CTM is preferably arranged for informing the user that his mobile equipment MS could be connected to a newly determined mobile network Ri which provides the chosen quality of service. This information is given to the user through the man/machine interface MMI. This can be done by displaying a dedicated message on the screen of the mobile equipment MS and/or by outputting a dedicated message with the loudspeaker of the mobile equipment MS.

If the user agrees with the change of mobile network Ri, he transmits an authorisation command to the analysis device D, by means of the man/machine interface MMI. When the control module CTM receives the authorisation command it orders to the communication module CM to try to connect its mobile equipment MS to the newly determined mobile network Ri.

If the user disagrees with the change of mobile network Ri, he transmits a deny command to the analysis device D, by means of the man/machine interface MMI. When the control module CTM receives the deny command it does not send any order to the communication module CM and the current connection is held on.

In a variant, the control module CTM may be arranged to decide either to automatically order to the communication module CM to try to connect its mobile equipment MS to the newly determined mobile network Ri if it does not receive any command from the user during a chosen time interval, or try to not send any order to the communication module CM if it does not receive any command from the user during a chosen time interval.

It is also important to notice that the access to a new service is preferably done according to the ETSI recommendations. So, the access is done through the newly determined mobile network Ri (PLMN), but not through a particular cell (or access point) determined by the mobile equipment MS, because this is not allowed by the standard. Indeed, the new service may be accessed through another cell (or access point) of the newly determined mobile network Ri than the one in which the determination has been performed, because the mobile equipment MS may have moved or because the new network Ri has decided to drive the mobile equipment MS towards such another cell (or access point).

It is also important to notice, that when the detection module DM has found at least two connectable mobile networks Ri, it may be arranged for selecting one of them. This selection can be done by means of at least one chosen criterion. For instance, a criterion may consist in selecting the connectable mobile networks Ri which has the highest priority into the user controlled PLMN selector or into the operator controlled PLMN selector.

In a variant, the detection module DM may be arranged to transmit the designation of every connectable mobile networks Ri it has determined to the control module CTM, in order it orders to the man/machine interface MMI to display these designations onto the screen, so that the user might select one of them.

The analysis device may also comprise a triggering module TM intended for activating or deactivating its detection module DM and its control module CTM at chosen moments in order they start or stop to determine a newly connectable mobile network Ri providing the chosen quality of service. Such a triggering module may be programmable in order to allow the user to define the periodicity of the network determination through the man/machine interface MMI.

Preferably, each time a new connection has been established consecutively to the action of the control module CTM, the latter re-activates the triggering module TM. This re-activation involves a temporary stopping of the determination of the connectable mobile networks by the detection module DM and the control module CTM.

The working of the analysis device D will be better understood thanks to the two following examples.

In a first example the definition of the chosen quality of service is “GPRS service”. In other words, if the user can access the GPRS service thanks to his subscription, the analysis device D of his mobile equipment MS will try to give him the possibility to get this GPRS service as often as possible.

If the user has activated the analysis device D of his mobile equipment MS, then this analysis device D determines if the current mobile network R1, to which the mobile equipment MS is connected to, provides the GPRS service (i.e. if its capabilities may offer the GPRS service). If this is the case the control module CTM re-activates the triggering module TM in order a new determination be carried out at the expiration of a programmed time interval.

If this is not the case (for instance because the current mobile network R1 is an UMTS network), the analysis device D determines (possibly when its internal modules DM and CTM have been activated by the triggering module TM) if a new connectable mobile network provides capabilities which may offer the GPRS service.

If none of the connectable mobile networks R2 and R3 provides capabilities which may offer the GPRS service then the control module CTM re-activates the triggering module TM in order a new determination be carried out at the expiration of the programmed time interval.

If a connectable mobile network (for instance R2) provides capabilities which may offer the GPRS service then the control module CTM asks to the user if he wants to get the GPRS service.

If the user agrees, the control module CTM orders to the communication module CM to try to connect its mobile equipment MS to the newly determined mobile network R2. Then the communication module CM tries to get the GPRS service near the new mobile network R2 (preferably according to the ETSI recommendations). If it succeeds, the control module CTM re-activates the triggering module TM in order a new determination be carried out at the expiration of the programmed time interval. If it fails, the control module CTM preferably orders to the communication module CM to proceed to the connection of the mobile equipment MS to the previous mobile network R1 (this avoid to apply the manual PLMN selection algorithm defined in the 3GPP TS 23.122), then it re-activates the triggering module TM in order a new determination be carried out at the expiration of the programmed time interval.

If the user disagrees with the change of mobile network Ri, the control module CTM does not send any order to the communication module CM and the current connection with the mobile network R1 is held on. It re-activates only the triggering module TM in order a new determination be carried out at the expiration of the programmed time interval.

In a second example the definition of the chosen quality of service is “the (radio) access technology based on a list of preferences”. In other words, if the user can access to one of his favourite (radio) access technologies (authorized by his subscription), the analysis device D of his mobile equipment MS will try to give him the possibility to get one of his favourite (radio) access technologies (if possible the most favourite) as often as possible.

If the user has activated the analysis device D of his mobile equipment MS, then this analysis device D determines if the current mobile network R1, to which the mobile equipment MS is connected to, provides one of his favourite (radio) access technologies (stored in a list).

If this is the case, the control module CTM re-activates the triggering module TM in order a new determination be carried out at the expiration of a programmed time interval. In a variant, the control module CTM determines if the current access technology is the most favourite one. If this is the case the control module CTM re-activates the triggering module TM in order a new determination be carried out at the expiration of a programmed time interval.

If this is not the case (or if the current access technology is not the favourite one), the analysis device D determines (possibly when its internal modules DM and CTM have been activated by the triggering module TM) if a new connectable mobile network provides (one of) the most favourite (radio) access technology.

If none of the connectable mobile networks R2 and R3 provides (one of) the most favourite (radio) access technology, then the control module CTM re-activates the triggering module TM in order a new determination be carried out at the expiration of the programmed time interval.

If a connectable mobile network (for instance R2) provides (one of) the most favourite (radio) access technologies, then the control module CTM asks to the user if he wants to get the GPRS service.

If the user agrees, the control module CTM orders to the communication module CM to try to connect its mobile equipment MS to the newly determined mobile network R2. Then the communication module CM tries to establish a connection with the new mobile network R2 (preferably according to the ETSI recommendations). If it succeeds, the control module CTM re-activates the triggering module TM in order a new determination be carried out at the expiration of the programmed time interval. If it fails, the control module CTM orders to the communication module CM to proceed to the connection of the mobile equipment MS to the previous mobile network R1, then it re-activates the triggering module TM in order a new determination be carried out at the expiration of the programmed time interval.

If the user disagrees with the change of mobile network Ri, the control module CTM does not send any order to the communication module CM and the current connection with the mobile network R1 is held on. It re-activates only the triggering module TM in order a new determination be carried out at the expiration of the programmed time interval.

The analysis device D according to the invention, and notably its detection module DM and control module CTM and the possible triggering module TM, may be realised with software modules. But, they may be also realised with a combination of hardware and software modules, or only with hardware (for instance, each of them may be at least a part of an integrated circuit (IC) realized in CMOS technology or in any technology currently used in chip factory). In an example of embodiment, the analysis device D may be part of the communication module CM of the mobile (or cellular) communication equipment MS.

The invention is not limited to the embodiments of analysis device, communication module CM and mobile (or cellular) communication equipment described above, only as examples, but it encompasses all alternative embodiments which may be considered by one skilled in the art within the scope of the claims hereinafter.

1. An analysis device adapted for a mobile communication equipment comprising a communication module for collecting information relative to mobile communication networks providing known capabilities which may offer service(s) which is connectable to said mobile communication equipment, comprising:
i) a detection means for determining from the information collected by said communication module if one of said connectable mobile communication networks to which said mobile communication equipment is not already connected is providing a chosen quality of service; and
ii) a control means for trying to connect said mobile communication equipment to the newly determined mobile communication network.

2. The analysis device according to claim 1, wherein said control means is operative for informing the user of said equipment that the latter can be connected to a newly determined mobile communication network providing said chosen quality of service, and for ordering said communication module to try to connect said equipment to said newly determined mobile communication network if it receives an authorization from said user through its equipment.

3. The analysis device according to claim 1 further comprising a triggering means for activating/deactivating said detection means and said control means at chosen moments in order that they start/stop to determine a newly connectable mobile communication network providing said chosen quality of service.

4. The analysis device according to claim 3, wherein said triggering means is of the programmable type.

5. The analysis device according to claim 1, wherein said detection means uses a definition of a chosen quality of service provided by the user by means of a man/machine interface of said equipment.

6. The analysis device according to claim 1, wherein said detection means builds a definition of a chosen quality of service from information relative to the subscription the user has contracted near a network operator and for using this defined chosen quality of service by default.

7-9. (canceled)

10. The analysis device of claim 1, further comprising a communication module.

11. The analysis device of claim 1, comprising a component in a mobile communication equipment.

12. The analysis device of claim 10, comprising a component in a mobile communication equipment.

13. A method of operating a mobile communication equipment comprising a communication module arranged for collecting information about mobile communication networks providing known capabilities which may offer service(s) and which is connectable to said equipment, the method comprising:
determining from the information collected by said communication module if one of said connectable mobile communication networks is providing a chosen quality of service and is not already connected to said mobile communication equipment; and
when one of said unconnected but connectable mobile communication networks is detected, ordering said communication module to try to connect said mobile communication equipment to said detected mobile communication network.

14. The method of claim 13, further comprising informing the user of said equipment that said equipment can be connected to a newly determined mobile communication network providing said chosen quality of service, and attempting to connect said equipment to said newly determined mobile communication network if it receives an authorization from said user through its equipment.

15. The method of claim 13, further comprising determining a newly connectable mobile communication network providing said chosen quality of service.

16. The method of claim 13, further comprising using a definition of a chosen quality of service provided by the user by means of a man/machine interface of said equipment.

17. The method of claim 13, further comprising building a definition of a chosen quality of service from information relative to the subscription the user has contracted near a network operator and for using this defined chosen quality of service by default.

18. The method of claim 13, further comprising providing a control module.

19. The method of claim 13, further comprising a providing a detection module.

20. The method of claim 13, further comprising a detection module, a control module, and a triggering module in communication with each other and with said communication module.
